(19) United States
(12) Patent Application Publication
(10) Pub. No.: US 2007/0230413 A1
(43) Pub. Date: Oct. 4, 2007

(54) Method for measuring airlink transmission latency in a 1x-EVDO wireless network

(75) Inventors: Asif D. Gandhi, Iselin, NJ (US); Mathew Thomas, Madison, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/393,228

(22) Filed: Mar. 30, 2006

(51) Int. Cl. H04Q 7/24

(52) U.S. Cl. 370/338; 370/252

(57) ABSTRACT

In a method for determining transmission latency in a wireless network, data packets addressed to a wireless unit are received at a radio network controller (RNC) and forwarded to a base station in communication with the wireless unit for transmission over the forward link. The RNC keeps track of when it receives the packets. Periodically, the base station sends messages back to the RNC. Each message identifies a data packet and the time it was transmitted to the wireless unit. The RNC uses the messages to calculate a data transfer rate, e.g., the number of packets between the first packet received by the RNC and the packet identified in the message, divided by the time difference between the message and when the first packet was received by the RNC. The RNC then applies the transfer rate to any data remaining for the wireless unit, to determine the transmission latency thereof.

### FIELD OF THE INVENTION

The present invention relates to communications and, more particularly, to wireless communication systems.

### BACKGROUND OF THE INVENTION

Wireless, radio frequency communication systems enable people to communicate with one another over long distances without having to access landline-connected devices such as conventional telephones. While early systems were primarily configured for voice communications, technological improvements have enabled the development of “3-G” (third generation) and similar wireless networks for both voice and high-speed packet data transfer. For example, CDMA-based, “1x-EVDO” (Evolution Data Optimized, or Evolution Data Only) wireless communication networks, now implemented in many parts of the U.S. and elsewhere, use the CDMA2000® 3-G mobile telecommunications protocol/specification for the high-speed wireless transmission of both voice and non-voice data. 1x-EVDO is an implementation of CDMA2000® that supports high data rates, specifically, forward link data rates up to 3.1 Mbit/s, and reverse link rates up to 1.8 Mbit/s in a radio channel dedicated to carrying high-speed packet data, e.g., a 1.25 MHz-bandwidth radio channel separate from the radio channel for carrying voice data.

Transmission latency or delay is a primary measure of system performance in wireless networks and other data systems. In a wireless network where data is transferred in packets, for example, transmission latency is typically measured as the time it takes for one or more packets to travel from a radio access network input, e.g., a radio network controller pre-buffer, to a base station including transmission out over the air. In “best efforts” 1x-EVDO wireless networks, “blocking”-type measures are unavailable, and data packets cannot be blocked based on delay. Eventually, all data bits will make it through for transmission over the air. Accordingly, one measure of how well the network is functioning (and whether it is at capacity) is the latency in transferring data packets across the wireless network.

Especially in 3-G and similar wireless networks involving high-speed data transfer, user perceived throughput (“UPT”) is also a valuable performance indicator. UPT is a sense or measure of how fast data is being received at a wireless unit, as actually perceived by the user. For example, in downloading a large file from the Internet, or in browsing web pages, users are typically not concerned with the average data throughput of the network, peak data rates, or similar generalized performance indicators. Instead, users are more typically interested in the amount of time for a batch data transfer, e.g., the time to download a particular file. In such a case, UPT may be measured as the ratio of download size (e.g., number of bits) to time, as measured from when the file is requested to when the download is completed. More generally, UPT may be characterized as the ratio of data size to the time between when the data is requested and when the data is received, in units of kbits/second (“kbps”) or the like.

### SUMMARY OF THE INVENTION

An embodiment of the present invention relates to a method for measuring data transmission latency in a wireless communication network. The wireless network may include a radio access network (“RAN”) portion having one or more base stations for radio communications with various wireless units and a RAN “front end” (possibly including a radio network controller) connected to the base stations. The RAN front end acts as the interface between the base stations and the rest of the wireless network or elsewhere, including coordinating the transfer of data to and from the base stations. By “wireless unit,” it is meant mobile phones, wireless PDA's, computerized vehicle navigation systems, wireless devices with high-speed data transfer capabilities, such as those compliant with “3-G” or “4-G” standards, “WiFi”-equipped computer terminals, or the like. In carrying out the method, the transfer rate of a first data set associated with the wireless unit is determined. By “associated with,” it is meant that the data set is configured or otherwise intended for transmission to the wireless unit. For example, the first data set may be one or more data packets addressed to the wireless unit. Subsequently, the transmission latency of a second data set associated with the wireless unit is determined by applying the transfer rate to the second data set. The second data set may be, e.g., one or more data packets remaining for transmission to the wireless unit.

In another embodiment, a message is transmitted from the base station to the RNC or vice versa. The message identifies the first data set, the second data set, or a portion thereof, e.g., one of the data packets in the first or second data set. The message also includes time information, such as when the data packet was received, or when it was transmitted. The transfer rate and/or the transmission latency is determined based on the time information in the message. For example, the transfer rate may be determined as an amount of data in the first data set, divided by the time difference between the time information in the message (e.g., identifying when the last data packet in the first data set was transmitted by the base station) and a time reference point of the first data set (e.g., the time when the first data packet in the first data set was received by the RNC).

In another embodiment, a time difference is determined between first and second time reference points. The reference points and the time difference relate to a first portion of a data set. For example, the time difference may indicate the amount of time required for the first portion of the data set to pass through a section of the wireless network. The data set is associated with a wireless unit, e.g., the data set may be a plurality of data packets addressed to the wireless unit, with the first portion comprising one or more of the data packets. One of the time reference points is included in a message received from the base station or RNC and that identifies the first portion of the data set. (The first portion can be identified generally, or through the identification of a sub-component thereof, e.g., one of the data packets in the data set.) Subsequently, the data transfer rate of the first portion of the data set is determined as the ratio of the quantity of data in the first portion to the time difference.

In another embodiment, a base station in wireless communication with one of the wireless units sends successive flow control messages to the radio network controller or other portion of the RAN front end. Each message relates to the transfer a designated amount of data over the RAN airlink to the wireless unit. For example, the flow control messages may be sent each time the base station completes the transfer of the designated amount of data, for purposes of requesting additional data for transfer or otherwise. (By “transfer,” it is meant the reception and/or transmission of data, and “airlink” refers to one or more radio frequency channels or other radio links of the wireless network.) Subsequently, the current data transfer rate of the airlink, as relating to the individual wireless unit, is determined based on the designated amount of data, and on a time difference between the flow control messages. For example, the data transfer rate may be determined as the ratio of the designated data amount to the time difference or vice versa. The flow control messages may include time data such as a time stamp for determining the time difference between the flow control messages.

In another embodiment, the transmission latency of the airlink is determined based on the data transfer rate as applied to any data remaining for transfer to or from the wireless unit. For example, the data transfer rate may be calculated as the ratio of the time between successive flow control messages to the designated data amount, with the transmission latency being estimated as the product of this ratio and the amount of data remaining for transfer. Thus, for example, if the transfer of 50 data packets is completed between the sending of two successive flow control messages spaced 40 milliseconds apart, and there are 180 packets remaining for transfer to or from the wireless unit, the transmission latency would be estimated as (40 ms/50 packets) 180 packets=144 ms, based on the particular observational interval between the successive flow control messages.

In another embodiment, a user perceived throughput (“UPT”) of the airlink is determined as the data transfer rate in terms of bits per second, or as the amount of data remaining for transfer to the wireless unit divided by the transmission latency. For example, if the transmission latency were 144 ms for 180 packets, the UPT would be 1.28 Mbps (assuming 1024 bits/packet). The UPT may be calculated at a number of different times for a number of different wireless units.

Data transmission rates, transmission latency, and UPT will typically be determined with respect to individual wireless units, on a wireless unit-by-wireless unit basis. This may be done for every wireless unit in communication with the wireless network, or for only a portion of the wireless units, or at certain times, e.g., when transferring large files. Calculations made at different times for an individual wireless unit may be statistically analyzed, as may calculations across multiple wireless units.

In addition to their use in determining transmission latency, the flow control messages may be used for requesting additional data from the network front end. For example, if a base station sends a flow control message to the network front end upon completing the transfer of a designated amount of data, the flow control message may act as a prompt for the network front end to commence sending additional data to the base station. In regards to this function, the flow control messages may be an existing feature of the wireless network.

### BRIEF DESCRIPTION OF THE DRAWINGS

The present invention will be better understood from reading the following description of non-limiting embodiments, with reference to the attached drawings, wherein below:

FIG. 1 is a schematic diagram of a method and system for determining airlink transmission latency on a wireless network according to an embodiment of the present invention;

FIG. 2 is a flow chart showing the steps of an embodiment of the method for determining airlink transmission latency;

FIG. 3 is a flow chart showing the steps of an additional embodiment of the method for determining airlink transmission latency;

FIG. 4 is a schematic diagram showing an additional embodiment of the system and method for determining airlink transmission latency;

FIG. 5 is a flow chart showing the steps of the method for determining airlink transmission latency in FIG. 4; and

FIGS. 6-8 are schematic diagrams showing additional embodiments of the system and method for determining transmission latency.

### DETAILED DESCRIPTION

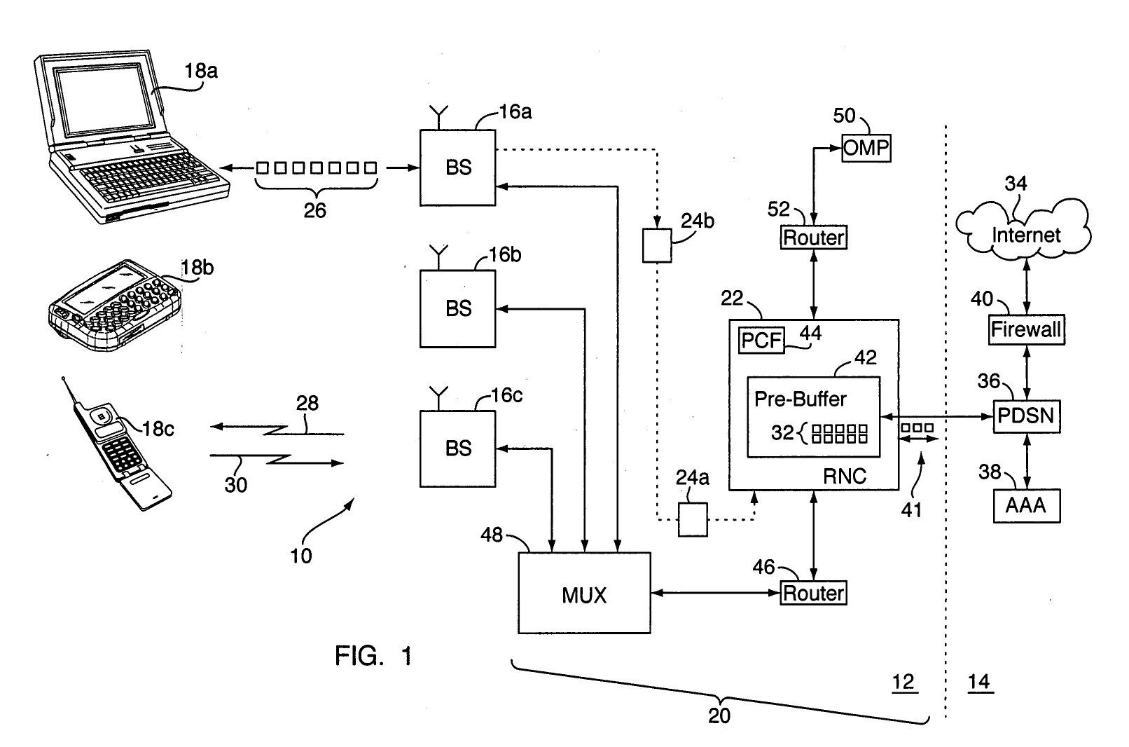

With reference to FIGS. 1-8, various embodiments of a method for measuring airlink transmission latency (and possibly other data transfer rate and related airlink characteristics) are implemented on or as part of a wireless communication network 10, e.g., a CDMA-based 1x-EVDO network or other wireless network. The wireless network 10 may include a radio access network portion (“RAN”) 12 and a core IP (Internet Protocol) network portion 14. The RAN 12 includes one or more fixed base stations 16a-16c (“BS”) each with various transceivers and antennae for radio communications with a number of distributed wireless units 18a-18c, e.g., mobile phones, “3-G” (third generation) wireless devices, wireless computer routers, and the like. The base stations 16a-16c are in turn connected to a RAN “front end” 20, which may include a mobile switching center and/or radio network controller (“RNC”) 22 and other components which together act as the interface between the base stations 16a-16c and core IP network 14, including directing data transfer to and from the base stations 16a-16c for transmission to the wireless units 18a-18c.

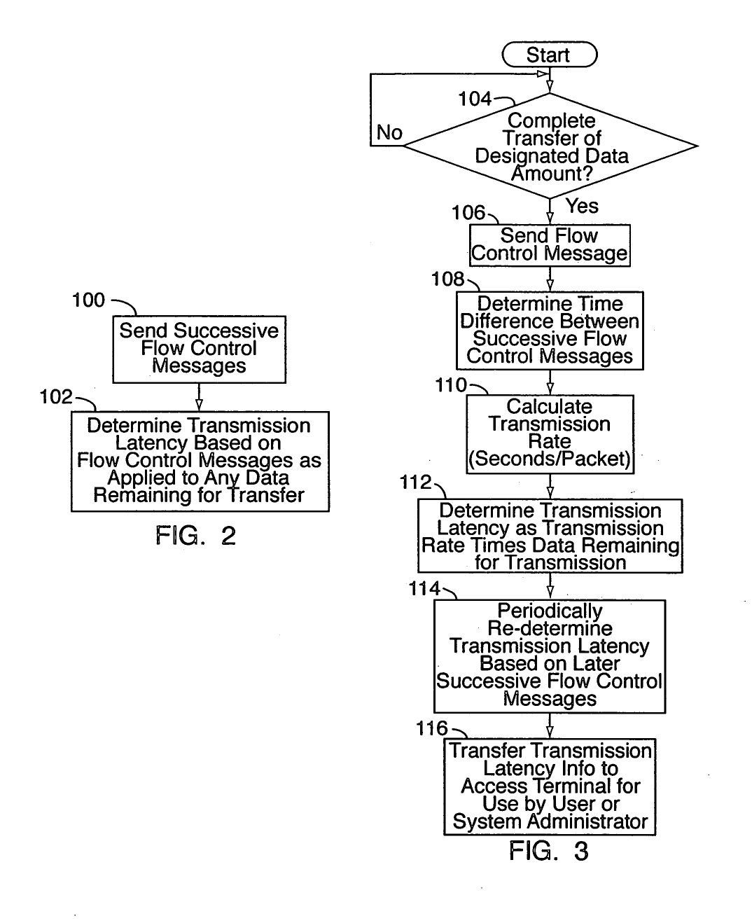

One embodiment of the method for measuring the airlink transmission latency, illustrated with respect to a base station 16a in communication with one of the wireless units 18a, is shown in FIGS. 1 and 2. At Step 100, the base station 16a, when communicating with the wireless unit 18a, sends successive flow control messages 24a, 24b to the RAN front end 20. Each message 24a, 24b is sent when the base station 16 completes the transfer of a designated amount of data 26 over the network airlink 28, 30 to the wireless unit 18. (By “transfer,” it is meant the reception and/or transmission of data. “Airlink” refers to any radio channel or link over which data is transferred, e.g., the forward and/or reverse radio links 28, 30 of the wireless network 10, respectively.) The flow control messages 24a, 24b may each contain time data such as a time stamp of when the message was generated or sent, for use in determining the transmission latency. Subsequently, at Step 102 the transmission latency of the airlink is determined based on the successive flow control messages 24a, 24b as applied to any data 32 remaining for transfer to or from the wireless unit 18a, as further discussed below. In other words, the transmission latency is a calculation of the projected time for transferring the remaining data 32 over the airlink.

As indicated above, the method of the present invention may be implemented on different types of wireless communications networks, for example the CDMA-based 1x-EVDO network 10 shown in FIG. 1. 1x-EVDO is an implementation of the CDMA2000® 3-G mobile telecommunications protocol/specification configured for the high-speed wireless transmission of both voice and non-voice data. For conducting wireless communications between the base stations 16a-16c and the wireless wireless units 18a-18c, the RAN 12 utilizes a CDMA (code division multiple access) spread-spectrum multiplexing scheme. In CDMA-based networks, transmissions from wireless units to base stations are across a single frequency bandwidth known as the reverse link 30, e.g., a 1.25 MHz bandwidth centered at a first designated frequency. Generally, each wireless unit 18a-18c is allocated the entire bandwidth all the time, with the signals from individual wireless units being differentiated from one another using an encoding scheme. Transmissions from base stations to wireless units are across a similar frequency bandwidth (e.g., 1.25 MHz centered at a second designated frequency) known as the forward link 28. The forward and reverse links may each comprise a number of traffic channels and signaling or control channels, the former primarily for carrying voice data, and the latter primarily for carrying the control, synchronization, and other signals required for implementing CDMA communications. The network 10 also utilizes another radio channel (e.g., a third 1.25 MHz frequency bandwidth) dedicated to carrying high-speed packet data, with forward link data rates up to 3.1 Mbit/s and reverse link rates up to 1.8 Mbit/s. The RAN 12 may be geographically divided into contiguous cells, each serviced by a base station, and/or into sectors, which are portions of a cell typically serviced by different antennae/receivers supported on a single base station.

The network 10 may be connected to external networks such as a public switched telephone network, or to the Internet 34. For high-speed data transmission to and from the Internet or elsewhere (e.g., for facilitating web browsing, real time file transfer, or downloading large data files), the network 10 may use the Internet Protocol, where data is broken into a plurality of addressed data packets. Additionally, voice over IP (“VoIP”) may be used for voice-data transmission. (With VoIP, analog audio signals are captured, digitized, and broken into packets like non-voice data.) Both voice and non-voice data packets are transmitted and routed over the wireless network, where they are received and reassembled by the wireless units to which the data packets are addressed. For use in transferring packet data between the RAN 12 and external networks such as the Internet 34 (or otherwise), the core IP network portion 14 of the wireless network 10 may include a packet data serving node (“PDSN”) 36 for routing wireless unit originated or terminated packet data, an authentication, authorization, and accounting module (“AAA”) 38, and a firewall 40.

In the wireless network 10, as shown in FIG. 1, packet data 41 (e.g., arriving from the Internet 34 for transfer to an wireless unit 18a) is typically routed from the PDSN 36 to the RNC 22. The RNC 22 may include an input pre-buffer 42 for temporarily storing packet or other data, and a packet control function 44 for managing the relay of data packets between the PDSN 36 and base stations 16a-16c. The packet data is subsequently forwarded to a concentrator router 46, and then over a high capacity line to a high capacity multiplexer 48 for transfer to the base stations 16a-16c. The wireless network 10 may also include an operations management platform (“OMP”) 50 connected to the RNC 22 through a router 52, for providing enhanced operations, administration, maintenance, and provisioning functionality.

An embodiment of the method for determining airlink transmission latency according to the present invention will now be explained in further detail with reference to FIGS. 1 and 3. As noted above, upon their arrival at the RNC 22 from the PDSN 36, data packets 41 are stored in the RNC pre-buffer 42. For controlling the flow of packets between the RNC 22 and base stations 16a-16c, as part of a RAN data flow control scheme that functions on a per-wireless unit basis, the base stations 16a-16c periodically send flow control messages 24a, 24b to the RAN front end 20, e.g., to the RNC 22, to request additional data. In particular, at Steps 104 and 106, each time one of the base stations 16a completes the transfer of a designated amount of data 26 to a wireless unit 18a-18c, the base station 16a sends a flow control message 24a, 24b to the RNC 22. (It is also possible for the messages to be sent elsewhere in the RAN front end.) Upon receipt of the flow control message 24a, 24b, the RNC 22 knows to send additional data to the base station 16a. The designated amount of data 26 may be a static, pre-determined value based on network parameters and/or upon a desired level of granularity in terms of both data flow and determinations of transmission latency. For example, the designated data amount 26 could be fifty data packets, in which case each base station 16a-16c would send a flow control message 24a, 24b upon completing the transfer of fifty data packets to an wireless unit, with the RNC 22 subsequently commencing the transfer of fifty additional data packets to the base station upon receipt of each flow control message.

As noted above, the flow control messages 24a, 24b may each contain a time stamp or other time data of when they were generated and/or sent. Alternatively, time calculations may be based upon time data of when the flow control messages are received by the RNC 22 or otherwise. In either case, the difference “Δt” in time data (“t_{message1}” and “t_{message2}”) between two successive flow control messages 24a, 24b received from a particular base station 16a in regards to a particular wireless unit 18a is determined at Step 108 in FIG. 3:
Δt=t_{message2}−t_{message1}
As should be apparent, Δt corresponds to the amount of time it took the base station 16a to get the designated amount of data 26 (e.g., 50 packets) out over the airlink. At Step 110, the transmission rate (“TR”) of the designated data amount 26 may be calculated as the ratio of the time Δt between successive flow control messages 24a, 24b to the designated data amount 26:
TR=Δt/(designated data amount)

To determine the transmission latency “TL,” the transmission rate TR between successive flow control messages 24a, 24b is multiplied by the data remaining for transfer 32, as at Step 112:
TL=TR·(data remaining for transfer)
TL=(Δt/(designated data amount))·(data remaining for transfer)
Conceptually, the transmission latency is the amount of time it will take for the remaining data 32 to be sent out over the airlink. Alternatively, the TL can be thought of as the time in the RAN for a new packet arriving at the pre-buffer to be sent over the airlink presuming that conditions remain “quasi-stationary.”

As an example, say that the designated data amount 26 is fifty data packets, that the time stamp on a first flow control message 24a (in regards to a particular wireless unit) indicates a time of 13:44:32.000, and that the time stamp on a second, successive flow control message 24b indicates a time of 13:44:32.040. Say also that 180 data packet exist throughout the RAN 12 for transfer to the particular wireless unit, e.g., there are 180 data packets stored in the pre-buffer 42 or elsewhere. Based on the above, the time difference Δt between the two flow control messages is 40 milliseconds:
Δt=t_{message2}−t_{message1}=13:44:32.040−13:44:32:000=40 ms
Then, the transfer rate TR is calculated as:
TR=Δt/(designated data amount)=40 ms/50 data packets=0.8 ms per data packet
Finally, the transmission rate is applied to the data remaining to transfer to determine the transmission latency, i.e., an estimate of how long it will take for the remaining data to go out over the air:
TL=TR·(data remaining for transfer)=(0.8 ms/data packet)·(180 data packets)=144 ms.
Thus, if conditions in the wireless network 10 do not change, the last packet of the remaining 180 data packets would take 144 ms to be sent out over the airlink. Alternatively, a new packet arriving at that instance would take 144 ms before it is at the head of the queue to be sent out over the airlink.

As noted, transmission latency will typically be determined for wireless units on an individual basis. Transmission latency may be determined for all the wireless units 18a-18c in communication with the wireless network, or only for some portion thereof, possibly based on certain types of activity. For example, determinations of transmission latency may be more relevant for situations involving large data transfers or the like. As indicated at Step 114, latency may be reevaluated periodically to capture changing RF and network conditions. Additionally, statistics can be evaluated as desired, including per-user averages, deviations, and averages over all users, using standard methods.

User perceived throughput (“UPT”) can be calculated in a similar manner as set forth above for determining transmission latency. In particular, as between successive flow control messages, UPT is determined as the ratio of bits transferred to Δt:
UPT=(designated data amount)·(bits/packet)/Δt [units: bits/sec]
(This assumes that the designated data amount is in units of packets; the designated data amount could be expressed in terms of bits, in which case there would be no need for a bits per packet conversion.) Thus, if there is a time difference Δt of 40 ms between successive flow control messages for a designated amount of data of 50 data packets, with each packet having 1024 bits:
UPT=(50 packets)·(1024 bits/packet)/40 ms=1.28 Mbits/sec (over this observation interval)
Similarly, UPT can also be calculated as the data remaining for transfer 32 divided by the transmission latency TL (again, as estimated based on a particular observation interval):
UPT=(data remaining for transfer)·(bits/packet)/TL
From the above example:
UPT=(180 packets)·(1024 bits/packet)/144 ms=1.28 Mbits/sec.
One difference to be noted is that while it is acceptable to aggregate data over all the different wireless devices (18a-18b) served by a specific BS (e.g., 16a) for the purpose of calculating the latency, for UPT the calculation has to be for a specific wireless device (e.g., for 18a only, or 18b only) as the concept of UPT is related to the throughput that is perceived or noticed an individual user.

As should be appreciated, a delay anywhere in the wireless network 10 (e.g., due to a busy transmission line or otherwise) will directly impact transmission latency and user perceived throughput. This is because an additional delay in the designated amount of data arriving at a base station will show up as an increase in the time difference At between two successive flow control messages 24a, 24b. For example (with reference to the example above where two successive flow control messages 24a, 24b are spaced 40 ms apart for a designated data amount of 50 packets), suppose that one of the transmission lines between the RNC 22 and a base station 16a becomes congested, resulting in an additional delay of 60 ms. If the next time that a flow control message is sent to the RNC 22 is 100 ms later (40 ms original delay+60 ms additional delay), the 50 packets (the designated data amount) took a total of 100 ms to transfer. If 180 data packets remain for transfer, the transmission latency would be estimated as:
TL=(Δt/(designated data amount))·(data remaining for transfer)=(100 ms/50 packets)·(180 packets)=360 ms
UPT=(designated data amount)·(bits/packet)/Δt=(50 packets)·(1024 bits/packet)/100 ms≈500 kbps
UPT=(data remaining for transfer)·(bits/packet)/TL=(180 packets)·(1024 bits/packet)/360 ms≈500 kbps

Although these examples are based on a value of 1024 bits per packet (a typical maximum value), the actual number of bits per packet may be smaller or larger than this amount. Information about the actual number of bits per packet, for purposes of calculating UPT, transmission latency, or the like, may be incorporated into the flow control messages 24a, 24b or otherwise provided in software or hardware, e.g., as a data portion of a script or computer program for carrying out the method of the present invention.

The impact of connection drops or gaps in the airlink connection would similarly be reflected in transmission latency and UPT. Also, an increased number of users would have a similar impact. In particular, with more users time-sharing the radio channel, each would have a smaller fraction of allocated slots. Thus, more time would be required for transmitting the same amount of data, which would be reflected in transmission latency and UPT. For example, suppose a first wireless unit 18a is located in a network cell or sector such that it gets a channel or slot data rate (i.e., the airlink may be logically divided into slots for transferring packet data) of 1.3 Mbps. If the user of the wireless unit downloads a file (e.g., a webpage from the Internet), and if there are two other wireless units 18b, 18c in that sector also active over the airlink, the RNC 22 (or the BS 16) will assign about ⅓ of the slots to each wireless unit 18a-18c. Thus, for the short period of several hundreds of milliseconds while the page is being downloaded, the first wireless unit 18a will perceive an effective rate of UPT=1.3 Mbps/3=433 kbps. From the perspective of the activity over the airlink as a whole, the data throughput is 1.3 Mbps. However, what is of interest to the first user is the transmission latency or UPT, as relating to his or her particular wireless unit, during times when actually transferring data, here about 433 kbps.

From the determinations of transmission latency and/or UPT as described above, jitter may also be calculated. “Jitter” is the variation in the user perceived throughput. For example, circuit-switched voice systems have a dedicated circuit with a constant UPT, meaning no jitter. In wireless networks, on the other hand, there may be variations in UPT due to factors such as variable loading (e.g., a changing number of active users) and changes in airlink conditions. Jitter may be calculated on a per-user basis, as a system average, or the like. Jitter may be calculated simply by taking the difference between successive UPT measurements, or by averaging the differences across several UPT measurements, including possibly correlating the resulting value(s) to a standardized scale or the like. For example:
UPTᵢₙₜₑᵣᵥₐₗ₁=500 kbps
UPTᵢₙᵥₑᵣᵥₐₗ₂=600 kbps
Jitter=UPTᵢₙₜₑᵣᵥₐₗ₂−UPTᵢₙₜₑᵣᵥₐₗ₁=100 kbps

Determinations of data transfer performance indicators such as UPT, transmission latency, and jitter may be made at different locations in the RAN 12, depending on the configuration of the wireless network and on how the UPT and transmission latency values are to be used. For example, instead of the UPT being measured at the RNC 22, the base stations 16a-16c could be configured to make note of the time data in successive flow control messages, and to calculate the UPT based on the time data and advanced knowledge of the designated data size 26 (assuming information regarding the amount of data 32 remaining for transfer was available to the base stations).

The methods described herein for determining transmission latency, UPT, and the like may be implemented using standard hardware and/or software techniques on a wireless network's existing equipment/infrastructure. For example, the RNC 22 could be outfitted with one or more scripts (i.e., computer programs) for calculating the time difference between successive flow control messages 24a, 24b, for calculating the data transfer rate, for determining transmission latency, etc. Of course, such scripts would also be configured for transmitting the information to a designated site or component for further use. For example, as at Step 116 in FIG. 3, the transmission latency or UPT could be sent for display on a wireless unit, or for display on a service provider terminal (not shown) connected to the wireless network 10, for use by technicians or network administrators.

Although the method of the present invention has been primarily described in regards to forward link transmissions, it is also applicable to reverse link transmissions. For example, in transferring a file across the wireless network 10, information regarding any data remaining for transfer (e.g., file size) could be supplied by the wireless unit transferring the data, and flow control messages could be sent either (i) from the RNC 22 to the base station for requesting additional data from the base station, or (ii) from the base station to the RNC 22, at the start or completion of transferring the designated amount of data 26, as a notice that data is being transferred (i.e., instead of as a request for additional data).

As indicated, the data transfer rate, transmission latency, UPT, etc. are typically determined in part based on the time difference between successive flow control messages 24a, 24b. As should be appreciated, by “successive” it is meant any two flow control messages relating to a single data transfer event for an wireless unit, and not necessarily two flow control messages that come one right after the other. For example, it is possible that as between three temporally contiguous flow control messages, a time difference between the first and third could be calculated, provided it is known that there was an intervening message for determining that there were two “groups” of the designated data amount 26 transferred during that time period.

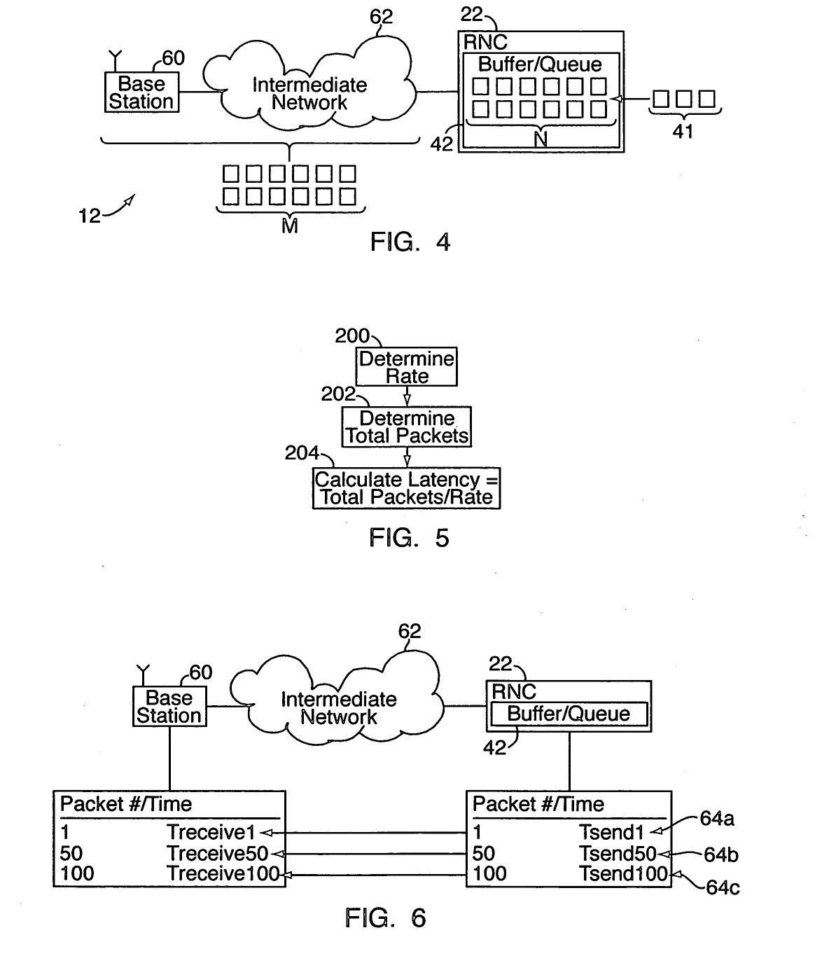

As should be appreciated, the method of the present invention is applicable for use in calculating transmission latency using means other than flow control messages 24a, 24b. FIGS. 4 and 5 show a more general embodiment of the method for calculating transmission latency. Here, the radio access network 12 is represented in simplified form, and includes the RNC 22, a base station 60, and an “intermediate network” 62 interconnecting the two. The intermediate network includes whatever queues and other network elements are interposed between the RNC 22 and base station 60 (such as the multiplexer 48 and router 46). In carrying out ongoing communication operations, packet data 41 (e.g., intended for a particular wireless unit 18a-18c) arrives at the RNC 22 and is stored in the pre-buffer or other queue 42. Subsequently, the packet data is routed out over the intermediate network 62 and to the base station 60 for transmission out over the forward link 28. At any given time, there may be “M” data packets in the intermediate network and base station, and “N” data packets in the RNC pre-buffer 42. To calculate latency, at Step 120 the transmission rate of packets (or other data) in the RAN 12 is determined. Then, at Step 122 the total number of packets “M+N” is determined; again, this represents the total number of packets remaining in the RAN 12 addressed to a particular wireless unit that have not yet been transmitted over the forward link. Then, at Step 124 the latency is calculated as:
Latency (seconds)=remaining data/rate=M+N (packets)/rate (packets/sec)

The rate can be determined in a number of different ways, e.g., as described above with respect to flow control messages. Alternatively, the rate can be approximated at the base station 60 by measuring the how fast packets come into the base station and/or how fast packets leave the base station. For example, if a data packet number “X” is at the top of the base station queue (for transmission over the forward link) at time t=t1, and data packet number “Y” is at the top of the base station queue some later time t=t2, then the rate could be approximated as rate=# packets/time=(Y−X)/(t2−t1). (This assumes that packets are consecutively numbered and that Y>X.) Thus, if a first packet is at the top of the base station queue at time t1=0, and the fifty-first data packet is at the top of the base station queue some time later, at t2=100 ms, then the transmission rate could be approximated as TR=(51'1) packets/100 ms=0.5 packet/ms.

The rate may also be calculated through the use of messages sent from the base station to the RNC or vice versa. Such messages may also be used for determining the total number of packets for calculating latency. Generally, each message will contain (i) information identifying a data packet, and (ii) time information associated with that data packet, e.g., a time of reception, transmission, or the like. The time information in the message is then compared to a time reference point relating to that data packet or another data packet, e.g., an earlier or later time point of when that data packet or another data packet was at a particular location in the RAN 12. In effect, the transmission rate is a calculation of the amount of packets flowing past a specific point in unit time. More accurate results may be obtained by configuring the system to determine the amount of time required for a plurality of data packets to traverse the RAN 12.

For example, the RNC 22 may be configured to send messages to the base station 60 relating to the times when particular packets were sent out over the intermediate network 62. This is shown graphically in FIG. 6. Here, as is typically done in a 1x-EVDO network, the packets are numbered on an RNC/base station basis, meaning that each packet is specifically identifiable. Periodically, the RNC 22 generates messages 64a-64c, each identifying a packet and the time the packet was transmitted. Alternatively, the messages may relate to when the messages were received at the RNC. For example, a first message might indicate that a packet #1 was sent at time “T_{send1},” a second, subsequent message might indicate that a packet #50 was sent at time “Tsend50,” and a third message might indicate that a packet #100 was sent at time “Tsend100.” The messages may be sent each time a certain number of packets is transmitted, such as every 50 packets, as above (e.g., packet/time format), or after a designated time period has elapsed (e.g., time/packet format):

| | |
|---|---|
| PACKET/TIME FORMAT | TIME/PACKET FORMAT |

| PACKET | TIME | TIME | PACKET |
|---|---|---|---|
| 1 | Tsend1 | 0 | 1 |
| 50 | Tsend50 | +50 ms | “X” (>1) |
| 100 | Tsend100 | +100 ms | “Y” (>X) |

The base station 60 receives the messages 64a-64c, and also tracks the times when the message packets arrive at the base station. For example, as indicated in FIG. 6, the base station might note that packet #1 was received at time “Treceive1”, that packet #50 was received at time “Treceive50”, and that packet #100 was received at time “Treceive100.” (It is also possible for the base station to track when the packets were transmitted out over the forward link.) Any of these can be used as a time reference point for calculating the transmission rate TR:
TR=total packets/(Treceive100−Tsend1)
As should be appreciated, this encompasses the entire time between when the RNC transmitted the first designated packet (packet #1) and the base station received (or transmitted over the forward link) the last designated packet, packet #100. “Designated” packet refers to packets within an observation window, not necessarily the first or last packets addressed to a wireless unit. Also, although “Tsend1” is contained in the message received at the base station from the RNC while “Treceive100” is determined at the base station, the base station and RNC have synchronized clocks for carrying CDMA communications.

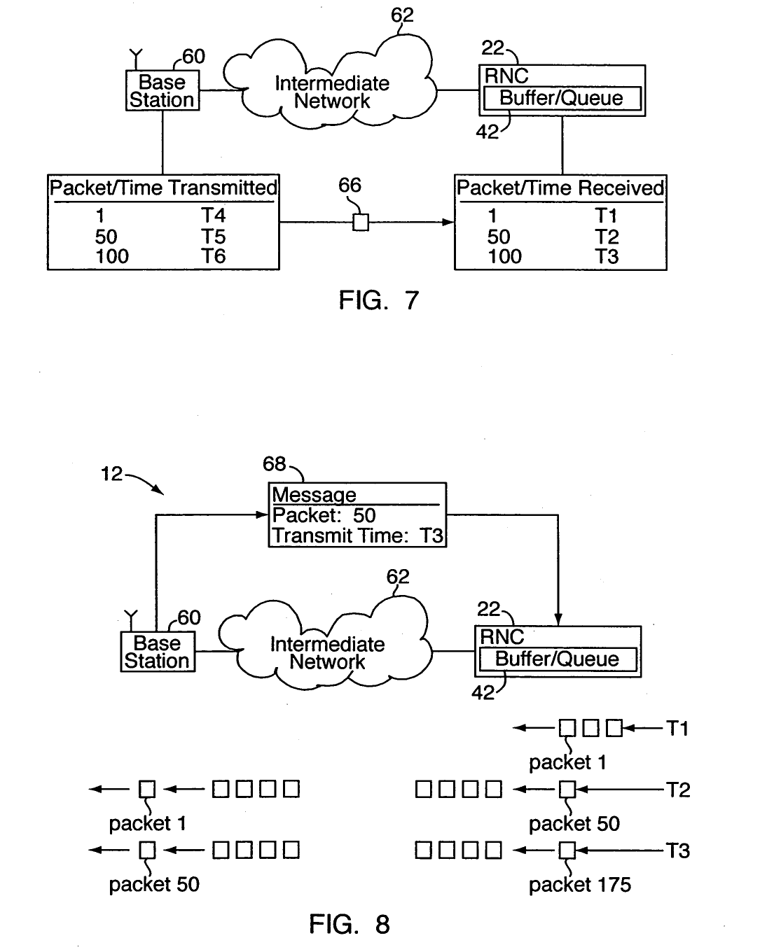

As shown in FIG. 7, instead of the RNC sending messages to the base station, the RNC may track when certain packets are received or transmitted by it. For example, in FIG. 7 packet #1 is received at the RNC at time T1, packet #50 at time T2, and packet #100 at time T3. The base station 60 periodically sends messages 66 back to the RNC indicating when the base station received or transmitted the packets. For example, a first message might indicate that the base station transmitted packet #1 at time T4, a second message might indicate that packet #50 was transmitted at time T5, and a third message that packet #100 was transmitted at time T6. The RNC would subsequently calculate the transmission rate as, for example, the total number of packets between first and last designated packets (#1 and #100) divided by the time difference between when the base station transmitted the last designated packet (“T6”), as indicated in a message 66 received by the RNC from the base station, and a time reference point of when the RNC received the first designated packet (“T1”).

Messages between the base station and RNC may also be used for determining the total number of data packets or other data queued in the radio access network 12 for transmission to a wireless unit, for latency calculations. The messages may be used simultaneously for both rate and latency calculations. This is shown graphically in FIG. 8. In an ongoing manner, data packets are received at the RNC, transmitted over the intermediate network, received at the base station, and transmitted by the base station over the forward link. Thus, at time T1, packet #1 is received at the RNC. At time T2, packet #50, for example, is received at the RNC, and packet #1, for example, is set for transmission over the forward link by the base station. At time T3, packet #175 is received at the RNC, and packet #50 is set for transmission over the forward link. At time T3 (or it could be at some other time), the base station 60 transmits a message 68 back to the RNC 22. The message identifies the current packet being transmitted over the forward link, e.g., the packet at the head of the base station transmission queue (here, packet #50), and the time of transmission (here, time T3). Using the information in this message, the RNC 22 is able to calculate the transmission rate as the amount of time required for a certain number of packets to make their way through the RAN 12. Here, packets #1-50 passed through the RAN 12 in the time period between T1 (a time reference point) and T3 (the time information in the message 68). Thus:
TR=50 packets/(T3−T1) seconds
The message 68 also identifies the “earliest” packet still left in the RAN 12, here, packet #50. Since the RNC 22 knows the identity of the packet that it most recently received prior to time T3, here, packet #175, the total number of packets remaining in the RAN 12 (e.g., addressed to a particular wireless unit) is 175−50=125. The latency can then be calculated as:
Latency=remaining packets/rate=(125/50)·(T3−T1) seconds

The timing and content of the messages may vary. For example, messages may be sent based on time or on the number of received packets, as noted above. Messages do not have to be sent continually. Instead, it is possible for messages to be sent in a staggered periodic manner, e.g., messages are sent during a 1-minute period, then no messages for 4 minutes, then messages for 1 minute, and so on. Also, the measurement points may vary, e.g., time information can relate to when packets are received, transmitted, or otherwise.

Since certain changes may be made in the above-described method for measuring airlink transmission latency in a 1x-EVDO wireless network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for determining transmission latency in a wireless network, said method comprising the steps of:
determining a transfer rate of a first data set associated with a wireless unit; and
determining a transmission latency of a second data set associated with the wireless unit based on the transfer rate as applied to the second data set.

2. The method of claim 1 further comprising:
determining a quantity of said second data set, wherein the transmission latency is determined based on the transfer rate as applied to said quantity of second data, and wherein the second data set comprises data remaining in at least a portion of the network for transmission to the wireless unit.

3. The method of claim 2 further comprising:
transmitting at least one message from a first network component to a second network component, wherein said at least one message identifies at least a portion of at least one of the first and second data sets, and wherein said at least one message includes time information associated with said at least a portion of at least one of the first and second data sets;
wherein at least one of the transfer rate and the transmission latency is determined at least in part based on said time information.

4. The method of claim 3 wherein:
said at least one message identifies a first data packet portion of the first data set; and
the transfer rate is determined based on (i) a time difference between the time information and a time reference point associated with one of the first data packet portion of the first data set and a second data packet portion of the first data set and (ii) an amount of data associated with the time difference.

5. The method of claim 4 wherein the quantity of the second data set is determined based on the first data packet portion of the first data set and a data packet portion of the second data set, said data packet portion of the second data set being associated with the time information.

6. The method of claim 1 further comprising:
transmitting at least one message from one of a base station and a radio network controller to the other of said base station and radio network controller, said message identifying a first data packet portion of the first data set and time information associated with the first data packet portion, wherein at least one of the transfer rate and the transmission latency is determined at least in part based on said at least one message.

7. The method of claim 6 wherein:
the transfer rate is determined as an amount of data in the first data set divided by a time difference between the time information and a time reference point, said time reference point relating to one of the first data packet portion and a second data packet portion of the first data set; and
the transmission latency of the second data set is determined as a ratio of an amount of data in the second data set to the transfer rate.

8. The method of claim 1 further comprising:
receiving at least two flow control messages each relating to the transfer of a designated amount of data to the wireless unit, said designated amount of data comprising at least a portion of the first data set; and
determining the transfer rate based on the designated amount of data and a time difference between the flow control messages.

9. The method of claim 8 further comprising:
sending each of said flow control messages upon completing transfer of the designated amount of data across a forward link of the network.

10. The method of claim 9 further comprising:
determining a user perceived throughput of the forward link as a ratio of the designated amount of data to the time difference between the successive flow control messages.

11. The method of claim 1 further comprising:
determining a user perceived throughput (UPT) of transmissions to the wireless unit based on the transfer rate.

12. The method of claim 11 further comprising:
determining at least two UPT values each at a different time; and
determining a jitter rate of transmissions to the wireless unit based on a difference between the at least two UPT values.

13. A method for determining a data transfer rate on a wireless network airlink, said method comprising the steps of:
determining a time difference between at least two flow control messages, wherein each of said flow control messages relates to the transfer of a designated amount of data across the airlink for a wireless unit; and
determining the data transfer rate based at least in part on the time difference and the designated amount of data.

14. The method of claim 13 further comprising:
sending each of said flow control messages upon completing the transfer of the designated amount of data across the airlink.

15. The method of claim 13 further comprising:
determining a transmission latency of the airlink as the product of the data transfer rate and data remaining for transfer to the wireless unit, wherein the data transfer rate is determined as a ratio of the time difference to the designated amount of data.

16. The method of claim 13 further comprising:
determining a user perceived throughput of the airlink as a ratio of the designated amount of data to the time difference.

17. A method for determining a data transfer rate in a wireless network, said method comprising the steps of:
determining a time difference between first and second time reference points each relating to a first portion of a data set associated with a wireless unit, wherein at least one of the time reference points is included in a received message identifying the first portion of the data set; and
determining a transfer rate of the first portion of the data set as a ratio of a quantity of data in the first portion to the time difference.

18. The method of claim 17 wherein the first time reference point relates to a first data packet in the first portion of the data set and the second time reference point relates to a second data packet in the first portion of the data set.

19. The method of claim 17 further comprising:
determining a transmission latency of a second portion of the data set as a ratio of an amount of data in the second portion to the transfer rate.

20. The method of claim 17 further comprising:
determining a user perceived throughput of the data set based on the transfer rate.
